(19) United States
(12) Patent Application Publication
(10) Pub. No.: US 2008/0110527 A1
(43) Pub. Date: May 15, 2008

(54) Circular Saw with a Dust-Collecting Hood

(76) Inventor: Hsin-Cheng Kuo, Taipei City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/843,146

(22) Filed: Aug. 22, 2007

(30) Foreign Application Priority Data
Nov. 13, 2006 (TW) 095219957

(51) Int. Cl. B27G 19/00

(52) U.S. Cl. 144/252.1

(57) ABSTRACT

A circular saw with a dust-collecting hood is to provide a circular saw structure with high dust-collecting efficiency, excellent safety and convenience in operation. By designing the dust-collecting hood and its location, the dust-collecting hood has surrounding wings to snugly attach to a main body of the circular saw and to further close two sides of a saw sheet so that small pieces and dust do not disperse and can be conducted into the dust-collecting hood by the air current when sawing. Moreover, an outer current is provided to suck the small pieces and dust out of the dust-collecting hood to significantly improve the dust-collecting efficiency. Because the structure is simple, the circular saw has low manufacturing cost and other advantages such as long lifetime and stable safety.

### BACKGROUND OF THE INVENTION

1. Field of the Invention

The present invention relates to a circular saw, and more particularly to a circular saw with a dust-collecting hood.

2. Description of Related Art

A conventional circular saw having dust-collecting efficiency, as shown in FIGS. 8 to 11, is used to cut a wood or similar material workpiece 1 and inevitably causes small pieces and dust 2. The conventional circular saw comprises a dust-collecting housing 3 with an interior space or a container to collect the small pieces and dust 2.

Beside the dust-collecting housing 3, the circular saw comprises a main body 8 and a base 9. The dust-collecting housing 3 is mounted beside the main body 8, and the base 9 is attached to a bottom of the main body 8. The base 9 is located on a flat surface of the wood or similar material workpiece. A saw sheet 4 is driven by a motor received inside the main body 8 and rotates counterclockwise thereby as shown in FIG. 8. In other words, a front end of the saw sheet 4 moves upward and a rear end of the saw sheet 4 moves downward. Then, the circular saw moves to the right side during sawing to cut the wood or similar material workpiece by the front end of the saw sheet 4 in upward rotation.

The small pieces and dust 2 caused during sawing are blown upward along arrow A by inertia force of the saw sheet 4 and air current caused by rotation of the saw sheet 4.

The dust-collecting housing 3 has an opening 7 (see FIG. 11) defined just over the front end of the saw sheet 4. The small pieces and dust 2 blown upward are immediately conducted into the interior space of the dust-collecting housing 3 via the opening 7.

After moving with the air current and passing the opening 7, the small pieces and dust 2 impact inner sidewall 5 and 6 of the dust-collecting housing 3 and then are rebounded by the inner sidewall 5 and 6. Otherwise, the small pieces and dust 2 will move to pass a space (see FIG. 10) closed to the inner sidewalls 5 and 6 and transport along the inner sidewalls 5 and 6 in accordance with arrow b. By the impact and long distance transportation, the small pieces and dust 2 are conducted into an air current in the dust-collecting housing 3 that reduces movement of the small pieces and dust 2 to separate from the air current. Therefore, the small pieces and dust 2 is deposited and collected at the bottom of the dust-collecting housing 3 and the air current is drained out of the dust-collecting housing 3 via the opening 7.

According to the above conventional circular saw, the small pieces and dust 2 must have a sufficient specific weight to drop and deposit on the bottom of the dust-collecting housing 3 when the air current decelerates. Thereby, the small pieces and dust 2 can be collected efficiently. However, the workpiece for treating or sawing is not wood only but includes siding material or concrete foaming material with light weight for constructing siding of houses or buildings. The siding material and light-weight concrete foaming material comprises cement as the main component so that the small pieces and dust 2 generated by cutting of the circular saw mainly contains cement dust that is too fine to be dropped or deposited easily on the bottom of the dust-collecting housing 3.

Therefore, the dust-collecting housing 3 in the above-disclosed conventional circular saw can not efficiently collect the small pieces and dust 2 when the small pieces and dust 2 has a small specific weight. When the specific weight is quite small, the small pieces and dust 2 conducted by the air current may be blown out of the dust-collecting housing 3 via the opening 7. Therefore, the dust-collecting efficiency is dramatically reduced.

Furthermore, as shown in FIGS. 8, 10 and 11, the dust-collecting housing 3 has a side wall 17 extending laterally and relatively to the saw sheet 4 so that the front end of the saw sheet 4 can be observed from the direction B. With the dust-collecting housing 3 having such structure, the conventional circular saw can not make free with being operated or interrupted at some special circumstance (operational circumstance such as sawing window).

The base 9 is generally made of punched steel and may be deformed when a strong force is applied thereon. The deformation of the base 9 causes an undesired gap between an opening 10 for the saw sheet 4 and the workpiece 1. The gap causes leakage of the small pieces and dust 2 from the dust-collecting hood and reduces the dust-collecting efficiency.

As shown in FIG. 10, a linkage rod 11 is provided on the base 9 to adjust the cutting depth of the saw sheet 4. When a strong force is applied during sawing operation, the linkage rod 11 may be bent or deformed. The bend or deformation destroys the vertical of the saw sheet 4 relative to the base 9 and causes result that the small pieces and dust 2 can not be linearly conducted into the dust-collecting housing 3 via the opening 7. Therefore, the dust-collecting efficiency is reduced.

Another conventional circular saw with dust-collecting efficiency further comprises a main body receiving a motor, a saw sheet driven by the motor, a base attached below the main body, a duct-collecting housing cover a top portion of the saw sheet for collecting the small pieces and dust, and a decelerating mechanism provided in the hood to reduce the small pieces and dust 2 when air current is conducted into the dust-collecting housing 3.

By providing the decelerating mechanism, the dust-collecting efficiency is improved by decelerating the air current containing the small pieces and dust but is limited in improvement without considering dispersion before the small pieces and dust are conducted into the air current and whither the air current can conduct all small pieces and dust to enter the predetermined entrance. Therefore, this conventional circular saw still needs to be improved.

### SUMMARY OF THE INVENTION

A main objective of the present invention is to provide a circular saw with a dust-collecting hood that is operated conveniently and has excellent dust-collecting efficiency.

To achieve the foregoing objective, the circular saw with a dust-collecting hood comprising:

a main body receiving a motor therein;

a saw sheet driven by the motor;

a base mounted below the main body;

a dust hood covering at least a part of the saw sheet and defining an interior space with an opening, and having an entrance defined oppositely to the opening.

By attaching the dust-collecting hood, the dust can be efficiently collected when the circular saw operates.

Further benefits and advantages of the present invention will become apparent after a careful reading of the detailed description with appropriate reference to the accompanying drawings.

### BRIEF DESCRIPTION OF THE DRAWINGS

FIG. 1 is a front view of a circular saw with a dust-collecting hood in accordance with the present invention;

FIG. 2 is a side view of the circular saw with a dust-collecting hood in accordance with the present invention;

FIG. 3 is a bottom view of the circular saw with a dust-collecting hood in accordance with the present invention;

FIG. 4 is a rear view of the circular saw with a dust-collecting hood in accordance with the present invention;

FIG. 5 is a perspective view of the circular saw with a dust-collecting hood in accordance with the present invention;

FIG. 6 is a bottom view of the dust-collecting hood in accordance with the present invention;

FIG. 7 is a cross-sectional side view of the dust-collecting hood in accordance with the present invention along line A-A in FIG. 6;

FIG. 8 is a front view of a circular saw with dust-collecting efficiency in accordance with the prior art;

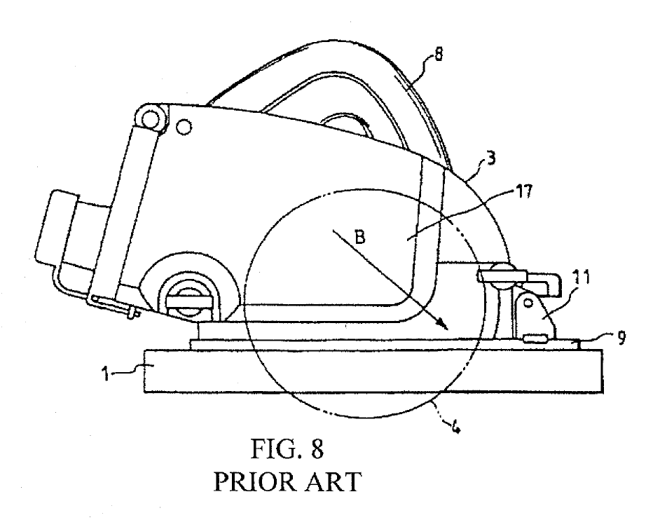

FIG. 9 is a bottom view of the circular saw with dust-collecting efficiency in accordance with the prior art, wherein a base of the circular saw is shown;

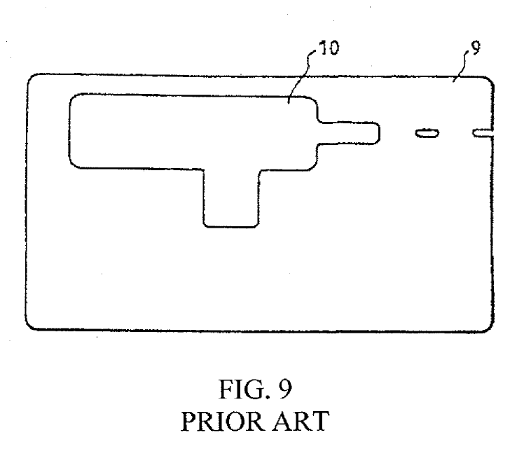

FIG. 10 is a partially cross-sectional view of the circular saw with dust-collecting efficiency in accordance with the prior art, wherein a right side of the circular saw is shown; and

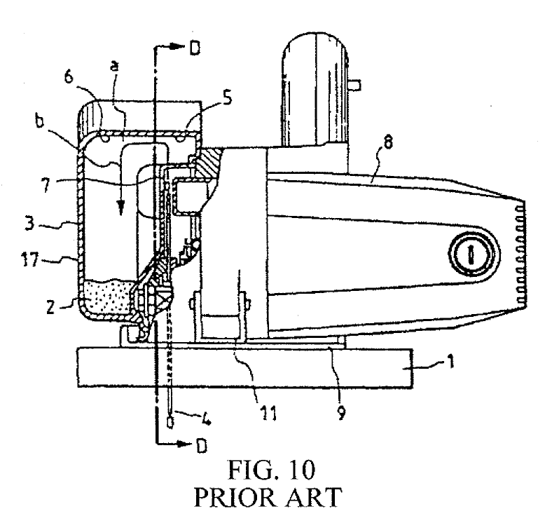

FIG. 11 is a cross-sectional view of the circular saw with dust-collecting efficiency in accordance with the prior art along line D-D in FIG. 10.

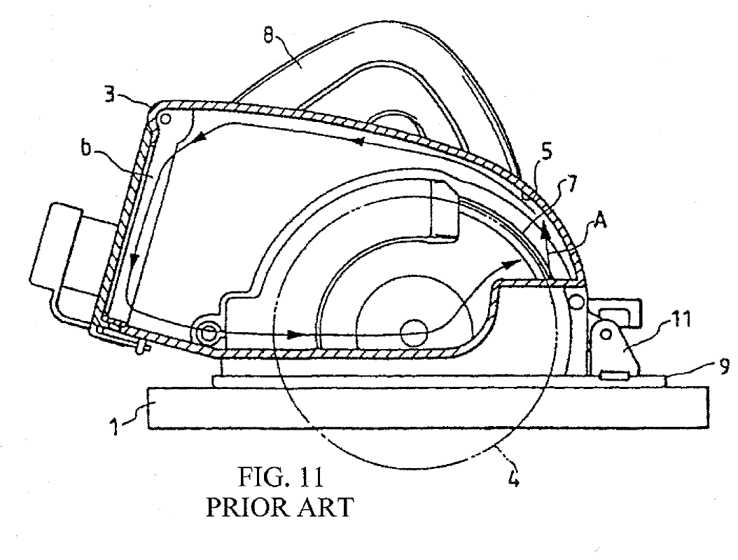

### DETAILED DESCRIPTION OF THE PREFERRED EMBODIMENT

A circular saw with a dust-collecting hood in accordance with the present invention is to provide a circular saw structure with high dust-collecting efficiency, excellent safety and convenience in operation. By designing the dust-collecting hood and its location, the dust-collecting hood has surrounding wings to snugly attach to a main body of the circular saw and to further close two sides of a saw sheet so that small pieces and dust do not disperse and can be conducted into the dust-collecting hood by the air current when sawing. Moreover, an outer current is provided to suck the small pieces and dust out of the dust-collecting hood to significantly improve the dust-collecting efficiency. Because the structure is simple, the circular saw has low manufacturing cost and other advantages such as long lifetime and stable safety.

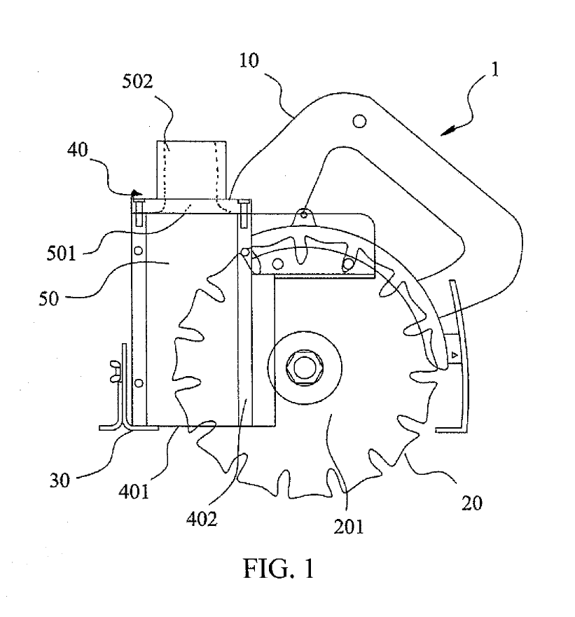

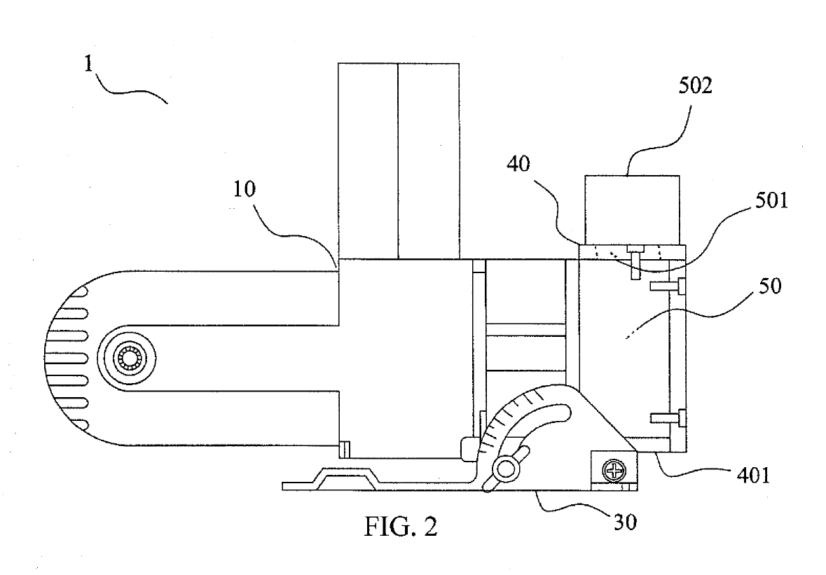

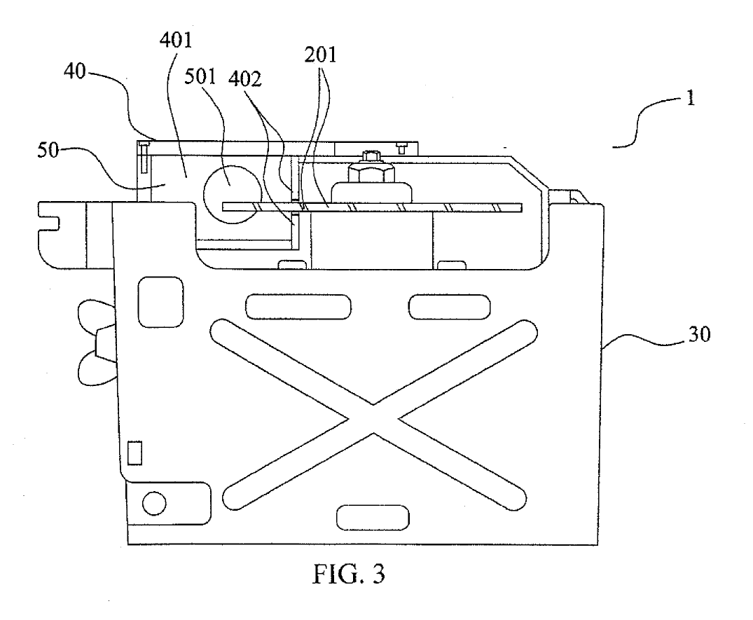

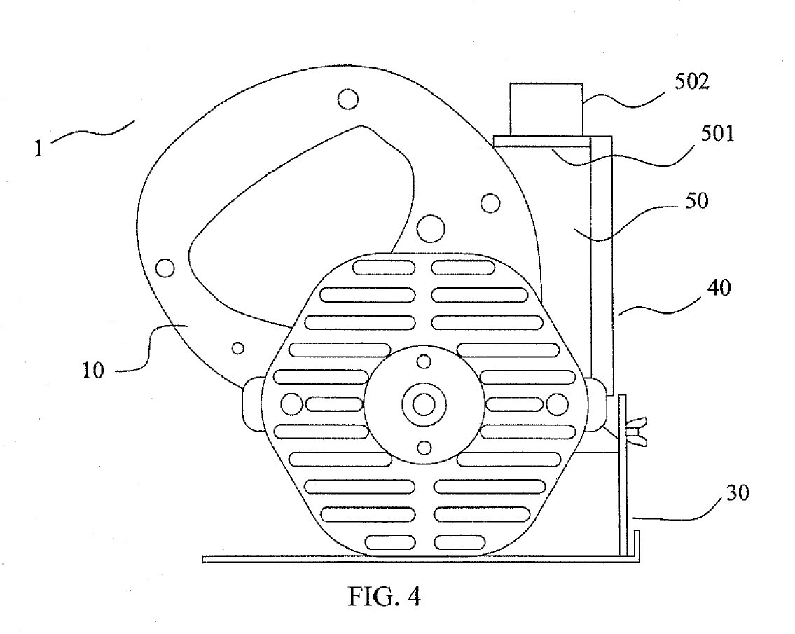

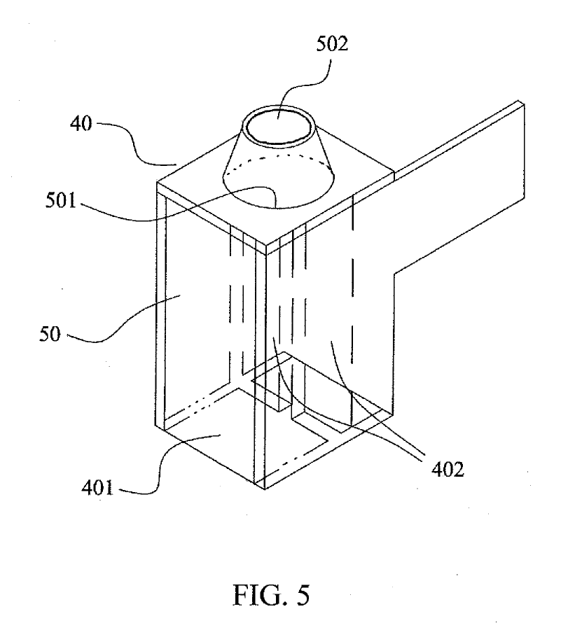

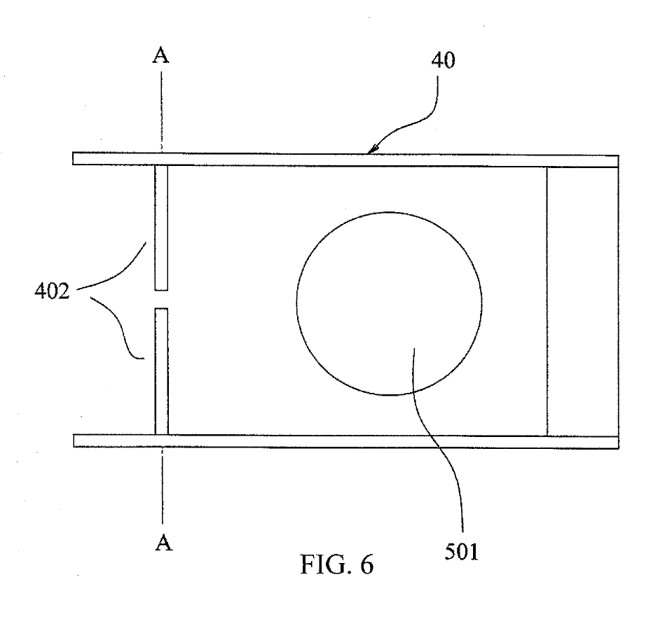

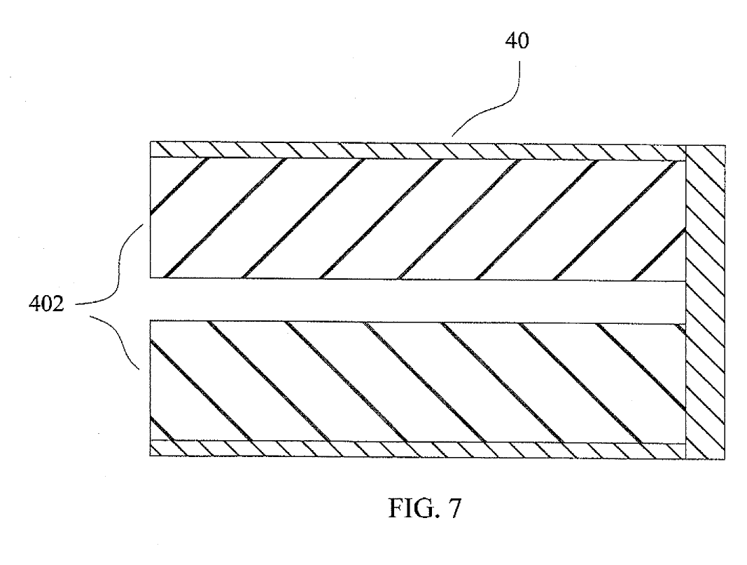

A preferred embodiment of the circular saw with a dust-collecting hood is shown in FIGS. 1 to 7 that illustrate the circular saw and the dust-collecting in perspective, bottom or cross-section views. The circular saw in this preferred embodiment comprise a main body 10 receiving a motor (not numbered), a saw sheet 20 driven by the motor, a base 30 attached below the main body 10 and made of an aluminum alloy cast, and a dust-collecting hood 40 with an entrance 401 and an interior space 50 to cover a part of the saw sheet 20 that is less than half of the whole saw sheet 20. Preferably, the covered part of the saw sheet 20 is from its rear end to its axial center of rotation. The dust-collecting hood 40 has a pair of portions non-parallel to the saw sheet 20 and extending to two sides of the saw sheet 20 to perform surrounding wings 402 and to define the gap between the surrounding wings 402 without blocking the movement of the saw sheet 20. Preferably, the surrounding wings 402 extend in direction vertical to the saw sheet 20. The entrance 401 is defined at bottom of the dust-collecting hood 40 to allow dust entering thereby. The dust-collecting hood 40 is made of Acrylic or plastic material that is easy to be processed and attached to the main body 10 by securing means such as screws. The dust-collecting hood 40 with an interior space 50 and an opening 501 has a truncated cone 502 mounted over the opening 501 to connect to an air-conducting device, wherein the opening 501 is opposite to the entrance 401. The interior space 50 in the dust-collecting hood 40 has a guiding angle at its junction sidewall in relative to the opening 501, wherein the guiding angle is over 90° and can be a fillet or a rake angle to make the air current inside the dust-collecting hood whirl smoothly without dead space. The air-conducting device is a fan or a vacuum machine and combines with the main body 10 by screws.

When the circular saw 1 operates, the saw sheet 20 rotates in clockwise direction and the dust generated during operation is carried by an air current and flows along the direction of the air currents. By using the foregoing dust-collecting hood 40, the dust generated during operating the circular saw 1 is isolated to prevent releasing to outside. Where, the surrounding wings 402 of the dust-collecting hood 40 located at two sides 201 of the saw sheet 20 ensure the dust to be collected inside the dust-collecting hood 40 without dispersing irregularly in different directions. Meanwhile, the air-conduction device attached outside the dust-collecting hood 40, such as fan or vacuum machine, increase the power of the air current that carries the dust to make the suction efficiency complete. Moreover, the air-conducting device guides the dust out from the dust-collecting hood 40 directly so that the circular saw 1 can be stopped the operation at anytime without dust dispersion problem.

According to above description, the circular saw with a dust-collecting hood not only improves the dust-collecting efficiency significantly but also reduces the manufacturing cost because it has a simple structure.

Although this invention has been described in its preferred form with a certain degree of particularity, it is understood that the present invention of the preferred form has been made only by way of example and that numerous changes in the details of construction and the combination and arrangement of parts any be resorted to without departing from the spirit and scope of the invention.

What is claimed is:

1. A circular saw with a dust-collecting hood comprising:
a main body receiving a motor therein;
a saw sheet driven by the motor;
a base mounted below the main body;
a dust hood covering at least a part of the saw sheet and defining an interior space with an opening, and having an entrance defined oppositely to the opening.

2. The circular saw with a dust-collecting hood as claimed in claim 1, wherein the dust-collecting hood has an entrance to allow an air current to bring the dust into the interior space.

3. The circular saw with a dust-collecting hood as claimed in claim 1, wherein the at least a part of saw sheet is less than half of the whole saw sheet and has a pair of surrounding wings non-parallel to the saw sheet and extending to the two sides of the saw sheet but without obstructing operation of the saw sheet.

4. The circular saw with a dust-collecting hood as claimed in claim 1, wherein the interior space and the opening have a guiding angle defined therebetween.

5. The circular saw with a dust-collecting hood as claimed in claim 4, wherein the guiding angle is a fillet or a rake angle.

6. The circular saw with a dust-collecting hood as claimed in claim 5, wherein the dust-collecting hood has a hollow truncated cone mounted over the opening to adapt to connect to an air-conducting device.

7. The circular saw with a dust-collecting hood as claimed in claim 5, wherein the dust-collecting hood has a tube mounted over the opening to adapt to connect to an air-conducting device.

8. The circular saw with a dust-collecting hood as claimed in claim 1, wherein the dust-collecting hood is made of Acrylic or other plastics that is easy to be processed.

9. The circular saw with a dust-collecting hood as claimed in claim 1, wherein the base is made of aluminum alloy cast.

10. The circular saw with a dust-collecting hood as claimed in claim 1, wherein the dust-collecting hood further has an air-conducting device communicating with the opening.

11. The circular saw with a dust-collecting hood as claimed in claim 10, wherein the air-conducting device is a fan.

12. The circular saw with a dust-collecting hood as claimed in claim 10, wherein the air-conducting device is a vacuum machine.

13. The circular saw with a dust-collecting hood as claimed in claim 1, wherein the dust-collecting hood is combined with the main body by screws.
